(19) United States
(12) Patent Application Publication
(10) Pub. No.: US 2024/0389784 A1
(43) Pub. Date: Nov. 28, 2024

(54) SYSTEMS FOR BREWING A BEVERAGE, AND RELATED COMPONENTS AND METHODS

(71) Applicant: MiiR Holdings, LLC, Seattle, WA (US)

(72) Inventor: Bryan Papé, Seattle, WA (US)

(73) Assignee: MiiR Holdings, LLC, Seattle, WA (US)

(21) Appl. No.: 18/689,799

(22) PCT Filed: Sep. 16, 2022
(86) PCT No.: PCT/US2022/043864

§ 371 Date: Mar. 6, 2024

Related U.S. Application Data
(60) Provisional application No. 63/245,012, filed on Sep. 16, 2021.

(51) Int. Cl. A47J 31/20; A23F 3/16; A23F 5/26

(52) U.S. Cl. CPC A47J 31/20; A23F 3/16; A23F 5/262

(57) ABSTRACT

A system for brewing a beverage such as tea and coffee, the system comprising: a container having a cavity to hold a liquid and grounds of material used to brew a beverage: a basket having a chamber to hold the grounds of material after the beverage is brewed: a press to move into the basket the grounds of material, and to remove the basket from the container's cavity to remove the grounds of material from the brewed beverage; a coupler to releasably secure the press to the basket when the press is positioned against the basket, the coupler being configured to secure the press to the basket while the basket's chamber holds grounds of material, and to keep the basket secured to the press while the press is removed from the beverage in the container's cavity; and wherein, while the beverage is brewing, the basket and the press are positioned inside the container's cavity such that the grounds of material are located between the basket and the press.

### CROSS REFERENCE TO RELATED APPLICATIONS AND INCORPORATION BY REFERENCE

This application claims priority from commonly owned U.S. PCT Patent Application PCT/US2022/043864 filed 16 Sep. 2022 and titled “SYSTEMS FOR BREWING A BEVERAGE, AND RELATED COMPONENTS AND METHODS”, and from commonly owned U.S. Provisional Patent Application 63/245,012 filed 16 Sep. 2021, and titled “SYSTEMS FOR BREWING A BEVERAGE, AND RELATED COMPONENTS AND METHODS”. This application also incorporates by this reference the entirety of U.S. PCT Patent Application PCT/US2022/043864, and the entirety of U.S. Provisional Patent Application 63/245,012.

### BACKGROUND

Many people prefer to make or brew coffee using a French press because a French press allows one much control over how the coffee tastes. To use a French press, one first submerges coffee grounds in a container of hot water for a period, and then traps and isolates the grounds at the bottom of the container while one pours the coffee in a cup to drink. Because one has control over the amount of coffee grounds submerged, and the duration of time that coffee grounds lie submerged in the hot water before pressing the coffee grounds to the bottom of the container, one can use a French press to brew coffee that has one of an infinite variety of tastes. This means that regardless of one's specific taste in coffee, one can brew coffee using a French press that satisfies one's taste. In addition, a French press is very portable and thus easy and convenient to brew coffee anywhere.

Unfortunately, a French press suffers from a couple of problems. Grounds sometimes slip into the coffee that one will be drinking. Cleaning a French press after use can also be annoying. And, because the coffee grounds never leave the container in which the coffee was brewed in, the brewed coffee can become over-extracted and taste bitter, dry, astringent, hollow, and empty if not promptly consumed. For this reason, coffee brewed using a French press should be consumed quickly before over-extraction adversely affects the coffee's taste.

Thus, there is a need for a French press that does not allow coffee grounds to slip back into the coffee that one will drink, that is easy to clean, and most importantly, that helps keep the brewed coffee from becoming over-extracted.

### SUMMARY

In one aspect of the invention, a system for brewing a beverage such as tea and coffee, includes a container, a basket, a press, and a coupler operable to releasably secure the press to the basket. The container has a cavity to hold a liquid and grounds of a material used to brew a beverage. The basket has a chamber to hold the grounds of material after the beverage is brewed. The press is operable to move into the basket's chamber the grounds of material, and to remove the basket from the container's cavity to remove the grounds of material from the beverage. The coupler is configured to secure the press to the basket while the basket's chamber holds the grounds of material, and to keep the basket secured to the press while the press is removed from the brewed beverage in the container's cavity. While the beverage is brewing, the basket and the press are positioned inside the container's cavity such that the grounds of material are located between the basket and the press. When one wants to stop the brewing process, one pushes the press toward the basket to direct the grounds of material into the basket's chamber. After the grounds of material are in the basket's chamber, one positions the press so that the coupler releasably couples the press to the basket. Then, one withdraws the press, and thus the basket from the container's cavity, leaving the freshly brewed beverage in the cavity.

With the ability to releasably couple the press to the basket after the grounds of material have been trapped in the basket, one can withdraw the basket and thus the grounds of material from the container as soon as the period for brewing expires. With this ability, one has much more control over the brewing period that generates the beverage, and can keep the grounds of material from being over extracted. This in turn allows the brewed beverage to be consumed over a longer period without losing its desired taste. The ability to remove the basket from the brewed beverage while the beverage remains in the container also helps prevent grounds of material from slipping or escaping back into the brewed beverage. In addition, with the basket removed from the container before drinking the brewed beverage, one can more easily clean the container and basket when finished. One does not have to dig out grounds of material from the bottom of the container when cleaning.

In another aspect of the invention, a method for brewing a beverage, such as tea and coffee, includes: 1) moving a press of a system for brewing a beverage toward a basket of the system, wherein the press and the basket are disposed in a cavity of a container of the system, the cavity also holding material brewing in a liquid to generate a beverage; 2) capturing the brewing material in a chamber of the basket; and 3) removing the basket with the captured brewing material in the basket's chamber from the container's cavity while the beverage remains in the cavity of the container.

### BRIEF DESCRIPTION OF THE DRAWINGS

FIG. 1 shows an exploded, perspective view of a system for brewing a beverage, according to an embodiment of the invention.

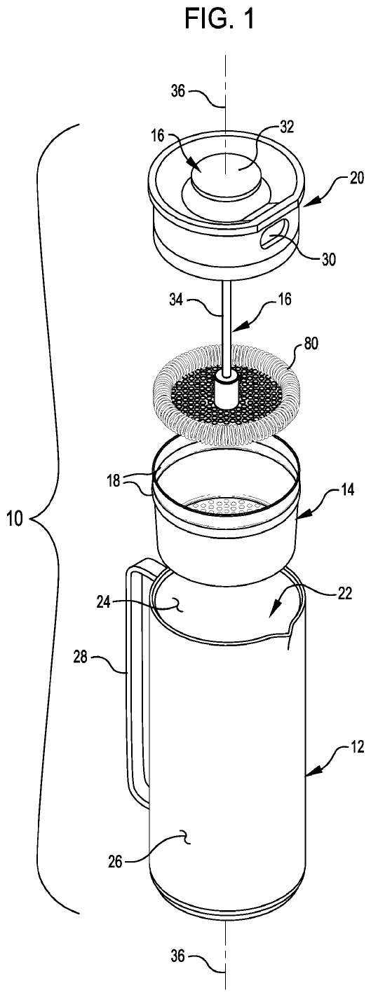

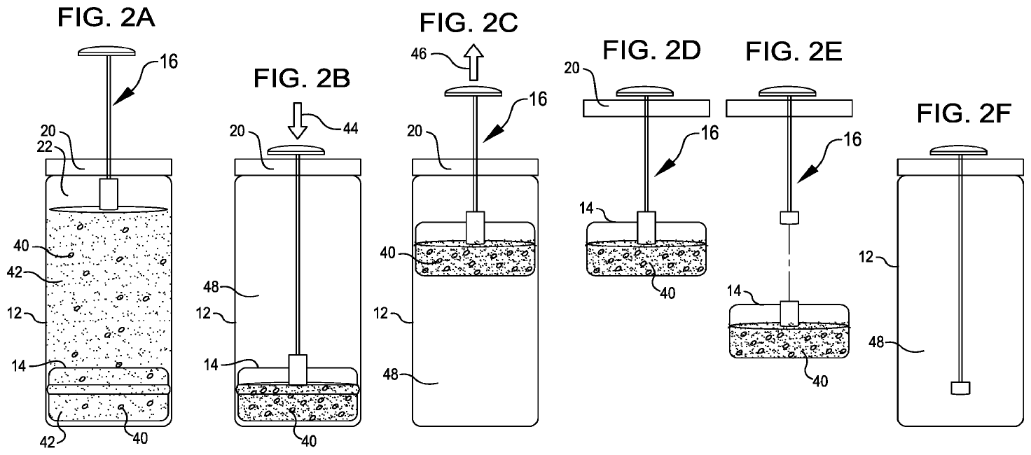

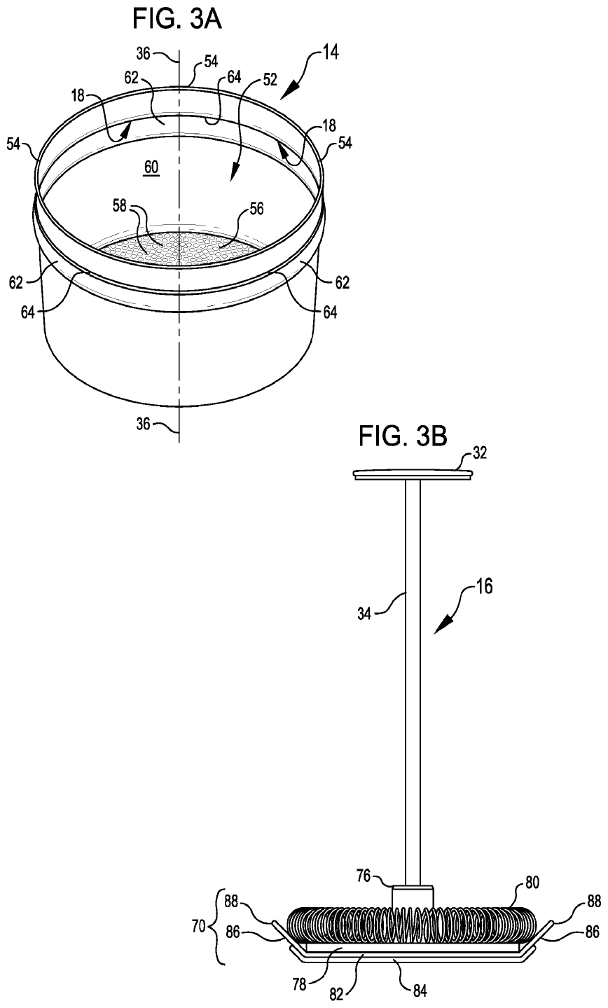

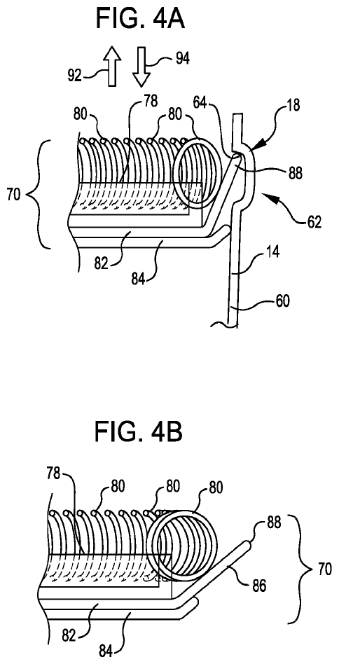

Each of FIGS. 2A-2F shows a view of the system shown in FIG. 1 during a different portion of a process for brewing a beverage, each according to an embodiment of the invention.

Each of FIGS. 3A and 3B shows a view of a component of the system shown in FIGS. 1 and 2, each according to an embodiment of the invention. FIG. 3A shows a perspective view of the basket component, and FIG. 3B shows a side view of the press component.

Each of FIGS. 4A and 4B shows a cross-sectional view of a portion of the press component shown in FIGS. 1, 2, 3A and 3B, each according to an embodiment of the invention. FIG. 4A shows the press with the basket component shown in FIGS. 1, 2, and 3A coupled together, according to an embodiment of the invention. FIG. 4B shows the press uncoupled from the basket, according to an embodiment of the invention.

### DETAILED DESCRIPTION

FIG. 1 shows an exploded, perspective view of a system 10 for brewing a beverage, according to an embodiment of the invention. The system 10 may be used to brew any desired beverage, such as coffee and tea, in which grounds, leaves and/or other material are first steeped in a liquid to extract flavor and/or other components of the grounds, leaves and/or other material, and then isolated from the liquid to allow one to drink the beverage, just brewed, free of the grounds, leaves and/or other material. To steep the grounds, leaves and/or other material in the liquid, the grounds, leaves and/or other material are soaked for a period of time in the liquid that may be cold, ambient temperature, warm or hot. The system 10 includes a container 12, a basket 14 (discussed in greater detail in conjunction with FIG. 3A), a press 16 (discussed in greater detail in conjunction with FIG. 3B), and a coupler 18 (discussed in greater detail in conjunction with FIGS. 4A and 4B) to releasably couple the basket 14 with the press 16. The container 12 holds the liquid and the grounds, leaves and/or material as they steep in the liquid, and afterwards, holds the beverage just brewed. The basket 14 captures and holds the grounds, leaves and/or other material after they have steeped in the liquid. The press 16 moves the grounds, leaves, and other material into the basket 14 when one finishes steeping the grounds, leaves, and other material. The coupler 18 allows one to remove the basket 14 from the container 12 while the brewed beverage remains in the container 12. The system 10 also includes a lid 20 that caps the container 12 to prevent the liquid and the grounds, leaves, and/or other material steeping in the container 12 from easily spilling out of the container 12. The lid 30 also helps keep the brewed beverage at the temperature desired.

With the ability to releasably couple the press 16 with the basket 14 after the grounds, leaves and/or other material have been trapped in the basket 14, one can withdraw the basket 14 and thus the grounds, leaves, and/or other material from the container 12 as soon as the steeping period expires. With this ability, one has much more control over the brewing period that generates the beverage, and can keep the grounds, leaves, and/or other material from being over extracted. This in turn allows the brewed beverage to be consumed over a longer period without losing its desired taste. The ability to remove the basket 14 from the brewed beverage while the beverage remains in the container 12 also helps prevent grounds, leaves and/or other material from slipping or escaping back into the brewed beverage. In addition, with the basket 14 removed from the container 12 before drinking the brewed beverage, one can more easily clean the container 12 and basket 14 when finished. One does not have to dig out grounds, leaves, and/or other material from the bottom of the container 12 when cleaning.

The container 12 may be configured as desired. For example, in this and other embodiments the container 12 is cylindrical and double-walled to insulate the liquid, steeping material, and brewed beverage. More specifically, the container 12 includes a cavity 22 in which the liquid, steeping material and brewed beverage are held. The cavity 22 is defined by the inner wall 24, which in this and other embodiments is a cylinder. The inner wall 24 is surrounded by an outer wall 26, and together the inner wall 24 and outer wall 26 define a region (not shown) between them that has less mass (in the form air here) than the mass of the air surrounding the system 20. By having the region 37 between the two walls 24 and 26 under vacuum, the region effectively insulates the cavity 22 from the temperature outside the system 10. The cylindrical shape of the inner wall 24 allows the press 16 to direct and control most if not all of the steeping material within the cavity 22. The container 12 also includes a handle 28 extending out, away from the outer wall 26. The inner and outer walls 24 and 26, respectively, may also be made of and desired material. For example, in this and other embodiments the inner and out walls are made of 304 stainless steel.

The lid 20 may also be configured as desired. For example, in this and other embodiments the lid 20 is configured to cover the cavity 22 when the lid 20 is positioned in the open top of the cavity 22. In this position, the lid 20 seals the cavity 22 from the outside environment, and only allows contents held in the cavity 22 to leave the cavity 22 via the passage 30. The lid 20 also includes a hole underneath the top 32 of the press 16 through which a shaft 34 of the press 16 extends. The hole is sized to provide a snug fit for the shaft 34 of the press 16 while the shaft 34 slides through the hole relative to the lid 20. This allows one to position the press 16 anywhere along the longitudinal axis 36 within the cavity 22 of the container 12. The lid 20 may also be made of and desired material. For example, in this and other embodiments the lid 20 is made of polypropylene.

Each of FIGS. 2A-2F shows a view of the system 10 shown in FIG. 1 during a different portion of a method for brewing a beverage, each according to an embodiment of the invention. The brewing method includes capturing the brewing material in a chamber of the basket 14 after the brewing material is finished steeping and while the basket 14 is disposed in the container's cavity 22; and then removing the basket 14 with the brewing material captured in the basket's chamber, from the container's cavity 22 while the brewed beverage remains in the container's cavity 22. With this brewing method one can retain or hold a brewed beverage in the same container 12 that the beverage was brewed in without the brewing method over extracting the flavors and other components of the brewed material into the brewed beverage. This, in turn, allows one much more control over the brewing method to allow one to more easily obtain a desired brew.

In this and other embodiments of the brewing method, the method begins by steeping grounds, leaves and/or material 40 in a liquid 42 (here coffee grounds 40 in hot water 42) as shown in FIG. 2A. During this stage of the process, the basket 14 is positioned at the bottom of the container's cavity 22, and the press 16 is positioned at the top of the cavity 22. Much of the grounds 40 are dispersed between the press 16 and the basket 14, with the remaining, few grounds 40 dispersed in the basket 14. As shown in FIG. 2B, once the grounds 40 have been steeped in the hot water 42 for a desired period, one moves the press 16 in the direction of the arrow 44 to direct all of the grounds 40 into the basket 14. After all of the grounds 40 are in the basket 14, one continues to move the press 16 into the top of the basket 14 until the coupler releasably captures the press 16 (discussed in greater detail in conjunction with FIGS. 4A and 4B). At this point, most if not all of the grounds 40 are captured in the basket 14. Next, as shown in FIG. 2C, one moves the press 16 back toward the lid 20 in the direction of the arrow 46 that is opposite the arrow 44. Because the coupler secures the basket 14 to the press 16, moving the press 16 in the direction of the arrow 46 also causes the basket 14 to move in the same direction-toward the lid 20. When the basket 14 reaches the top of the cavity 22, one may continue to move the press 16 in the direction of the arrow 46 to withdraw the basket 14 from the container's cavity 22. FIG. 2D shows the basket 14 withdrawn from the container's cavity 22. Next, as shown in FIG. 2E, the portion of the press 16 that the coupler secures to the basket 14, is releasably separated from the other portion of the press 16, so that the lid 20 may be re-positioned in the open top of the container's cavity 22 (shown in FIG. 2F) to cover the container's cavity 22 and help keep the brewed beverage 48 contained within the cavity 22 and hot for prolonged enjoyment.

Other embodiments of the process are possible. For example, a second lid 20 may positioned to cover the container's cavity 22 instead of using the lid 20 that holds the press 16.

Each of FIGS. 3A and 3B shows a view of a component of the system 10 shown in FIGS. 1 and 2, each according to an embodiment of the invention. FIG. 3A shows a perspective view of the basket 14, and FIG. 3B shows a side view of the press 16. The basket 14 includes a basket chamber 52 in which the brewing material is captured after one finishes steeping the material.

Referring to FIG. 3A, the basket 14 may be configured as desired to receive and hold the brewing material. For example, in this and other embodiments, the basket 14 is configured to mimic the configuration of the container's cavity 22 to facilitate capturing the brewing material, and to include the coupler 18 (discussed in greater detail in conjunction with FIGS. 4A and 4B). More specifically, the diameter of the basket 14 at it's widest section—the mouth 54 of the basket's chamber 52, and the coupler 18—is about 0.5 millimeters less than the diameter of the container's cavity 22, which provides a tight clearance fit. With the specific embodiment of the coupler 18, the short difference in the diameters between the basket 14 and the container's cavity 22 helps the couple 18 secure the basket 14 to the press 16 while withdrawing the basket 14 from the cavity 22. It does this by keeping the basket 14 substantially normal or perpendicular to the longitudinal axis 36 (FIG. 1)—i.e., the walls of the cavity 22 prevent the basket 14 from swinging or clocking, thus keeping the basket 14 aligned with the press 16 to allow the coupler 18 to secure the basket 14 to the press 16 while one pulls on the press out of the container's cavity. In addition, the basket's chamber 52 has a volume of about 350 cm³, which is about one quarter of the volume of the container's cavity 22.

The basket 14 also includes a bottom 56 that helps define the basket's chamber 52, and that is configured to allow liquid to flow into and out of the basket's chamber 52 while preventing grounds, leaves, and/or other brewing material from flowing through bottom 56. For example, in this and other embodiments, the bottom 56 includes many small holes 58 (only 4 labeled for clarity) dispersed throughout the bottom 56, each of which is smaller in size than the grounds, leaves and other brewing material being steeped in the container's cavity 22. When brewing a beverage that requires small or fine grounds, one can use a basket 14 whose bottom 56 has a large number of small holes across the whole bottom 56. And when brewing a beverage that requires large or course grounds, one can use a basket 14 whose bottom 56 has fewer, larger holes across the whole bottom 56 or a portion of the bottom 56. With more than one basket 14, each configured for a different-sized brewing material, one can easily brew different beverages with the same system 10. In other embodiments, the basket may include a removable filter coupled with the holes 58 through the bottom 56 to allow one to use a basket 14 configured for large brewing-material grounds to trap smaller brewing-material grounds.

The basket 14 also includes a wall 60 that helps define the basket's chamber 52, and that may be configured as desired. For example, in this and other embodiments, the wall 60 is configured to include the coupler 18. More specifically, the wall 60 includes a groove 62 that is formed in counter-relief or intaglio to the surface of the basket's wall 60, and couples the press 16 with the basket 14 when the groove 62 receives the press 16. The groove 62 includes a wall 64 (more easily seen in FIG. 4A) that is oriented such that a line normal to the wall's surface lies close to parallel with the longitudinal axis 36, when the basket 14 is positioned in the container's cavity 22 as shown in FIG. 2A. The groove 62 may extend along the whole circumference of the basket chamber 52 (as shown here in FIG. 4A), or along one or more portions of the circumference. Additionally, the groove 62 may extend any desired depth sufficient to receive and hold the press while one withdraws the bucket 14 from the container's cavity 22. For example, in this and other embodiments, the groove 62 has a depth that is about 1.8 mm. The groove 62 may also extend any desired length along the wall 60 in the direction that is parallel to the axis 36. For example, in this and other embodiments, the groove 62 has a length along the wall 60 that is about 7 mm.

FIG. 3B shows a side view of the press 16, according to an embodiment of the invention. The press 16 moves and directs the grounds, leaves, and/or other brewing material into the basket 24 when one finishes steeping the grounds, leaves, and/or other brewing material.

The press 16 may be configured as desired to accomplish this function. For example, in this and other embodiments the press 16 is similar to a conventional French-press filter. More specifically, the press 16 includes a plunger 70, the top 32, the shaft 34, and a coupler 76. The plunger 70 is configured to divide the container's cavity 22 into two separate volumes when the plunger 70 is disposed and moved inside the cavity 22 (FIGS. 2A and 2B). One of the volumes contains the grounds, leaves, and/or other brewing material as they steep in the liquid held in the container's cavity 22. The other volume contains liquid absent the grounds, leaves, and/or other brewing material. As one moves the plunger 70 away from the open top of the container 22 (FIGS. 2A and 2B), the plunger 70 allows liquid to pass from one volume to the other, but does not allow the grounds, leaves, and/or brewing material to pass. To provide this function, the plunger 70 includes a disk 78, a spring 80 coupled with the disk 78, a screen 82, and a support plate 84. The disk 78, screen 82, and support plate 84 are releasably coupled together such that they, and thus the spring 80, too, move as one when one moves the plunger 70 into, within, and out of the container's cavity 22. The coupler 76 may be configured as desired to releasably couple the plunger 70 to the shaft 34. For example, in this and other embodiments the coupler 76 includes a conventional quick-release connector.

The screen 82 may be configured as desired. For example, in this and other embodiments, the screen 82 includes a periphery 86 and an edge 88, and is configured to allow liquid to flow through it while preventing grounds, leaves, and/or other brewing material from doing the same. Thus, when the plunger 70 is moved inside the container's cavity 22 toward the basket 14 (FIGS. 2A and 2B), the plunger 70 allows the brewed beverage to flow into and out of the two volumes in the container's cavity 22 while directing the grounds, leaves, and/or other brewing material toward and into the basket's chamber 52. More specifically, the screen 82 is configured such that the edge 88 contacts the inside surface of the container's cavity 22 when the plunger 70 is positioned in the cavity 22 as shown in FIG. 2A, and contacts the inside surface of the wall 60 when the plunger 70 is positioned in the basket's chamber 52 as shown in FIGS. 2B-2E, and 4A. The spring 80 is configured to urge the screen's periphery 86 toward the inside surface of the cavity 22 while the plunger 70 is moved within the cavity 22, and toward the wall 60 while the plunger 70 is moved into the basket's chamber 52. This ensures that the screen's edge 88 remains in contact with either the inside surface of the cavity 22 or the basket's wall 60 as one moves the plunger 70. Once the edge 88 of the screen 82 is received by the groove 62 of the basket 14 and positioned against the wall 64 of the coupler 18, the spring 80 helps prevent buckling of the screen's periphery 86 by keeping the periphery 86 properly oriented within the groove 62, and thus the edge 88 properly oriented against the coupler's wall 64. The support plate 84 is configured to hold the screen to the disk 78 and to support the screen's periphery 86, and thus edge 88, on the side of the screen 78 opposite the side that spring 80 contacts.

The spring 80 may be any desired spring capable of urging the screen's periphery 86 toward the cavity's inside surface and the basket's groove 62. For example, in this and other embodiments, the spring 80 is a torsion spring whose helical body extends, through a series of holes (some of which are shown in FIG. 4A) in the disk 78, around the perimeter of the disk 78 to form a toroid. By extending through the series of holes in the disk 78, the spring 80 is coupled with the disk 78. In its natural, un-sprung state, the toroid formed by the spring 80 has an outside diameter greater than the diameter of the container's cavity 22. Thus, the spring 80 resists being compressed to an outside diameter that is less than the diameter of the cavity 22, which causes the spring 80 to urge the screen's periphery 86 toward the cavity's inside surface, and thus the edge 88 against the inside surface.

Each of FIGS. 4A and 4B shows a cross-sectional view of a portion of the plunger 70 shown in FIG. 3B, each according to an embodiment of the invention. FIG. 4A shows the plunger 70, and a coupler 18 of the system 10 releasably securing the plunger 70 to the basket 14 shown in FIGS. 1, 2, and 3A, according to an embodiment of the invention. FIG. 4B shows the plunger 70 uncoupled from the basket 14, according to an embodiment of the invention. Together FIGS. 4A and 4B illustrate how the coupler 18 releasably secures the press 16 of the system 10 to the basket 14, according to an embodiment of the invention, so that one may withdraw the basket 14 from the container's cavity 22 after the material 40 (FIGS. 2A-2E) has been captured in the basket's chamber 52.

Referring to FIG. 4A, the coupler 18 may be any desired coupler capable of releasably securing the press 16 to the basket 14. For example, in this and other embodiments, the coupler 18 includes the groove 62 formed into the wall 60 of the basket 14. More specifically, the groove 62 is located inside the basket's chamber 52 and near the top of the chamber 52 to allow ample volume inside the basket's chamber 52 for capturing and holding the material used to brew the beverage 48 (FIGS. 2B, 2C, and 2F). Allowing ample volume inside the basket's chamber 52 allows one to brew a beverage having any desired strength by allowing any one to use any desired amount of material 40 (FIGS. 2A-2E) for the brew. Allowing ample volume also facilitates the withdrawal of the basket 14 from the brewed beverage 48 by trapping most if not all of the material 40 in the basket's chamber 52 without tightly packing-compressing—the material 40 much like one packs coffee grounds into a filter of an espresso machine to make a shot of espresso. If the material 40 is tightly packed into the basket's chamber 52, then the brewed beverage 48 will not easily flow through the basket's chamber 52 as the basket 14 is withdrawn from the container's cavity 22 (FIGS. 1 and 2A), which may cause some of the brewed beverage to be forced out of the cavity 22.

In this and other embodiments, the groove 62 is configured to snag the screen 82 of the press's plunger 70 when the edge 88 of the screen 82 is disposed in the groove 62 and the plunger 70, and thus the screen 82, is moved in the direction indicated by the arrow 92; but to not snag the screen 82 when the edge 88 of the screen 82 is moved in the direction indicated by the arrow 94 and across the groove 62. To accomplish this, the groove 62 is formed in counter-relief or intaglio to the surface of the basket's wall 60, and the wall 64 of the groove 62 closest to the top of the basket's chamber 52 is oriented such that a line normal to the wall's surface lies close to parallel with the longitudinal axis 36 (FIG. 1). More specifically, the line lies within ±15 degrees of parallel with the longitudinal axis 36. With this orientation, the angle of the screen's periphery 86 with the wall's surface when the screen's edge 88 contacts the wall's surface is close to 90 degrees if not 90 degrees. Because the spring 80 is configured to urge the screen's edge 88 against the inside surface of the container's cavity 22, the spring 80 is further compressed when the plunger 70 is inserted into the basket's chamber 52. For context, FIG. 4B shows the position of the spring 80 of the plunger 70 when the spring 80 is not compressed by either the inside surface of the container's cavity 22 or the wall of the basket's chamber 52. In response to the further compression, the spring 80 urges the edge 88 of the screen 82 into the groove 62 when the edge 88 is adjacent the groove 62, and holds the edge 88 in the groove 62. With the screen's periphery 86 positioned 90 degrees or close to 90 degrees relative to the surface of the groove's wall 64, the screen's periphery 86 experiences a compressive load substantially directed through the screen's periphery 86 when the plunger 70 is moved in the direction indicated by the arrow 92. To keep the screen's periphery 86 from changing its orientation relative to the surface of the groove's wall 64 while the periphery 86 experiences the compressive load, the remaining portion of the groove 62, the spring 80, and the support plate 84 constrain the periphery 86. To release the plunger 70 from the coupler 18 and the basket 14, one may clock the basket 14 relative to the plunger 70 by moving a portion of the screen's periphery 86 in the direction indicated by the arrow 94, and then pulling the plunger 70 out of the top of the basket's chamber 52.

Other embodiments are possible. For example, the coupler 18 may include a receiver that extends from the bottom 56 of the basket 14 into the basket's chamber 52, and a bar that extends from the bottom of the plunger 70 away from the shaft 34 such that when the plunger 70 is releasably coupled with the basket 14, the coupler 18 extends through the basket's chamber 52. As another example, the coupler 18 may include a pincer in the plunger 70 that is configured to grasp the lip of the basket 14 when the plunger 70 contacts the lip.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A system for brewing a beverage such as tea and coffee, the system comprising:
a container having a cavity to hold a liquid and grounds of material used to brew a beverage;
a basket having a chamber to hold the grounds of material after the beverage is brewed;
a press to move into the basket the grounds of material, and to remove the basket from the container's cavity to remove the grounds of material from the brewed beverage;
a coupler to releasably secure the press to the basket when the press is positioned against the basket, the coupler being configured to secure the press to the basket while the basket's chamber holds grounds of material, and to keep the basket secured to the press while the press is removed from the beverage in the container's cavity; and
wherein, while the beverage is brewing, the basket and the press are positioned inside the container's cavity such that the grounds of material are located between the basket and the press.

2. The system of claim 1 wherein the container is insulated to keep liquid warm.

3. The system of claim 1 wherein the container's cavity is cylindrical.

4. The system of claim 1 wherein:
the container's cavity has a volume, and
the basket's chamber has a volume that is about 25% of the cavity's volume.

5. The system of claim 1 wherein the basket has a shape that mimics the container's cavity, and is sized to have a tight clearance fit when positioned in the container's cavity.

6. The system of claim 1 wherein the basket includes many small holes to allow liquid to flow through the basket while trapping captured grounds of material.

7. The system of claim 1 wherein the press includes a plunger that:
is sized and configured such that when the press is positioned in the container's cavity, the plunger divides the container's cavity into two separate volumes, a first volume in which the basket is disposed in, and a second volume, and
has a screen to allow the beverage to flow from the first volume to the second volume while not allowing grounds of material to do the same.

8. The system of claim 7 wherein the plunger includes a disk having a perimeter, and a spring surrounding the disk, the spring sized and configured to keep the plunger's screen in contact with the container while the plunger moves toward the basket.

9. The system of claim 1 wherein the coupler includes a groove located in a wall of the basket, the groove sized and configured to receive and hold a screen of the press's plunger when the press is positioned against the basket.

10. The system of claim 1 wherein:
the press includes a plunger sized and configured such that when the press is positioned in the container's cavity, the plunger divides the container's cavity into two separate volumes, a first volume in which the basket is disposed in, and a second volume, the plunger having:
a screen to allow liquid to flow from the first volume to the second volume while not allowing the grounds of material to do the same,
a disk having a perimeter, and
a spring surrounding the disk and coupled with the disk along the disk's perimeter, the spring sized and configured to keep the screen in contact with the container while the plunger moves toward the basket; and
the coupler includes a groove located in a wall of the basket and extending around the circumference of the basket, the groove sized and configured to receive and hold the plunger's screen when the press is positioned against the basket.

11. The system of claim 1 wherein the press includes a shaft releasably coupled with a plunger, the shaft configured to slide through a hole in a lid of the system.

12. A method for brewing a beverage, such as tea and coffee, the method comprising:
moving a press of a system for brewing a beverage toward a basket of the system, wherein the press and the basket are disposed in a cavity of a container of the system, the cavity also holding grounds of material in a liquid to brew a beverage;
capturing the grounds of material in a chamber of the basket; and
removing the basket with the captured grounds of material in the basket's chamber from the container's cavity while the beverage remains in the cavity of the container.

13. The method of claim 12 wherein moving the press includes pushing the press toward a bottom of the container's cavity.

14. The method of claim 12 wherein capturing the grounds of material in the chamber of the basket includes the press directing the grounds of material into the basket's chamber.

15. The method of claim 12 wherein capturing the grounds of material in the chamber of the basket includes locating the basket at the bottom of the container's cavity.

16. The method of claim 12 wherein removing the basket with the captured grounds of material in the basket's chamber while the beverage remains in the container includes releasably coupling the press with the basket.

17. The method of claim 12 wherein removing the basket with the captured grounds of material in the basket's chamber while the beverage remains in the container includes positioning a plunger of the press at an opening of the basket's chamber and releasably coupling the plunger with the basket such that the chamber is closed.

18. The method of claim 12 wherein removing the basket with the captured grounds of material in the basket's chamber while the beverage remains in the container includes inserting a screen of a plunger of a press into a groove located in a wall of the basket.

19. The method of claim 12 wherein removing the basket with the captured grounds of material in the basket's chamber while the beverage remains in the container includes the beverage flowing through the plunger of the press, through the basket's chamber, and through a bottom of the basket.

20. The method of claim 12 further comprising:
uncoupling a shaft of the press from the press's plunger, and
inserting the press's shaft into a receiver in a lid of the system.

21. The method of claim 12 further comprising pouring the beverage from the container's first cavity into a cup.
